(19) United States
(12) Patent Application Publication
(10) Pub. No.: US 2012/0125993 A1
(43) Pub. Date: May 24, 2012

(54) PLANAR DATA CARRIER

(75) Inventors: Jan Thiele, Chemnitz (DE); Sascha Voigt, Bernsdorf (DE); Andre Kreutzer, Mittweida (DE)

(73) Assignee: Printechnologics GMBH, Chemnitz (DE)

(21) Appl. No.: 13/120,996

(22) PCT Filed: Oct. 15, 2009
(86) PCT No.: PCT/EP2009/007578

§ 371 Date: Aug. 16, 2011

Related U.S. Application Data
(60) Provisional application No. 61/113,407, filed on Nov. 11, 2008.
(60) Provisional application No. 61/121,975, filed on Dec. 12, 2008.
(60) Provisional application No. 61/122,473, filed on Dec. 15, 2008.

(30) Foreign Application Priority Data
Oct. 15, 2008 (EP) 08075828.7
Nov. 4, 2008 (EP) 08075863.4
Nov. 16, 2008 (DE) 202008015342.5
Dec. 5, 2008 (DE) 202008016187.8
May 15, 2009 (EP) 09075230.4

(51) Int. Cl. G06K 19/02; G06F 17/00; G06K 7/08

(52) U.S. Cl. 235/375; 235/488; 235/451

(57) ABSTRACT

The invention relates to a data carrier or a group of such data carriers which allow for accurate correlation of information, the use of these data carriers, as well as a reading device, by means of which a data carrier via its structured information layer is associated with an action of a data processing system or can trigger the said action. More particularly, the invention also relates to a game card system that learns the unique playing characteristics of players and allows the processing of other game-related data, whereby the system comprises the use of game cards and collector cards over the Internet (online) as well as via a local data processing system (offline), and where, accordingly, the invention relates to a particularly preferred embodiment, that is a combination of the traditional collector card game with computer and video games. More preferably, the invention also serves as an access system for cards and debit cards for payment systems using the data carrier with a unique code that is readable using a reading device.

The invention relates to a data carrier or a group of such data carriers which allow for accurate correlation of information, the use of these data carriers, as well as a reading device, by means of which a data carrier, due to its structured information layer, can be associated with a random action of a data processing system or can trigger such an action. More particularly, the invention also relates to a game card system that allows the unique association of players and other game-related data, whereby the system comprises of playing cards and/or collector cards which may be used via the Internet (online) as well as through local data processing systems (offline); accordingly, the invention relates in a particularly preferred embodiment to a combination of the classic trading card game with computer and video games. In a particularly preferred embodiment relates the invention also cards for to access systems and debit cards for payment systems, which represent data carriers and comprise a code that is readable via a reading device.

Various planar print materials or data carriers that can be produced by various coating methods are known in the state of the art. Thus, EP 1 803 562 discloses a method for the transfer of image-bearing layers from a carrier foil or transfer foil to printed sheets in a sheet processing machine, at least with a sheet processing machine for the pictorial or surface coating of a printed sheet with an adhesive and at least one coating unit for transmitting image-bearing or covering layers from the carrier foil to the sheet being formed in a coating unit, whereby a transfer gap is formed in the coating device and the transfer foil is laid along the top of the press roller with the side coated with transfer material on a printed sheet and fed together with it under pressure through the transfer gap, so that the image-bearing or covering layers are transferred from the carrier foil onto the printed sheets in areas covered with adhesive, whereby the foil sheets are fed to the printing press with a printed or coated or non-printed or uncoated first side through a transfer gap with an image-bearing or full-surface foil coating provided by the carrier foil, whereby the said foil sheet can be dried before and/or after application of the foil coating.

DE 20 2006 013 070 U1 discloses methods and means for the production of structures of functional materials which can be used, for example, for playing cards where the cards have a code arrangement that can be visualized by a computer. In the document DE 10 2008 013 509 A1, a steganographical method is described which can make invisible security features in printed products visible by means of this transfer foil technology. The verification or visualization of these features is carried out optically using a decoder. Furthermore, a security feature produced by means of transfer foil technology is known from DE 10 2006 031 795 A1. In this method, resistances or resistance networks are introduced into printed products to show a security hallmark. The verification is carried out by contact with a reading device, which measures the resistances according to the ohmic principle.

A data carrier produced by means of a transfer foil technique in accordance with the claims is currently unknown.

In U.S. Pat. No. 5,818,019, U.S. Pat. No. 3,719,804, U.S. Pat. No. 4,587,410 and U.S. 2006/0118612 are disclosed, inter alia, flat printed materials that allow for secure verification or validation of data. This can, for example, be meaningful for medicines and their packaging but also for lottery tickets. The printed information ensures, for example, secure authentication or serves to verify the validity. Also capacitance-sensing data carriers are known from the applications U.S. Pat. No. 3,719,804 (permanent information storage device) and U.S. Pat. No. 4,587,410 (parking system) among others. In U.S. Pat. No. 3,719,804, production possibilities are disclosed using printing technologies such as, for example, screen printing, flexo printing and gravure printing. The description refers to materials which can be processed in liquid form and which are suitable for printing processes. The individualization is carried out by means of separation techniques of the applied conductor tracks. The reading procedure is strongly position-dependent and is linked to a fixed reading position of the data carrier in the reading device.

In U.S. Pat. No. 4,587,410, the processing and changeability of capacitance for a parking meter is shown. Using a mechanical unit, the capacitance in the reading device is modified gradually and thus its “inner value” changed. An individualization of the structures is not planned. The complete system is a self-sufficient system without interaction with other systems, data processing or data storage.

Further, in EP 0 569 520 or in DE 10 2008 013 509 procedures for printing are disclosed in which conductive elements are used or can be printed in order to implement information on a printable surface in order to allow the printed materials to be individualized, for example, for a reading device. The products derived using the disclosed method can be used, for example, in logistics supply, in postal dispatching or goods' tracking.

The solutions proposed in the state of the art have several disadvantages. They are, for example, not cheap enough for mass application, are only imperfectly recyclable due to their complex construction, are sometimes easy to copy, generate high costs during the application to the end-products, or cannot, or can only poorly, be further processed in the printing process.

The object of the invention, therefore, is to provide an inexpensive and efficient planar data carrier with a clear association that can be easily read and evaluated. It is also the object of the invention to improve the variability of the reading process and to enable that additional optical functions can be implemented on the data carrier.

It was quite surprising that the technical problem was solved via devices and systems according to the independent claims, with advantageous embodiments are reflected in the dependent claims. For the solution of the above problem, it is proposed, according to the present invention, to provide a data carrier, in particular a planar data carrier, on which an adhesive layer is at least partly applied to an electrically non-conductive substrate, a thereto, by adhesion to the adhesive layer, congruently applied at least single-layered information layer, whereby the said adhesive layer and information layer are layers applied via transfer process, preferably through a foil transfer process, and especially preferred through a cold foil transfer process and wherein at least one area of the structured information layer serves at the same time as an encoder for a capacitive reading device. The structured information layer may, in particular, be made from metals, graphite, carbon black, or other dielectric materials known to the person skilled in the art.

According to the invention, the structuring of the information layer of the data carrier takes place through, in particular, the adhesive. A preferred embodiment is where this adhesive is applied directly in a logical arrangement or layout on a substrate (print substrate) and then brought into contact with a transfer foil (see, for example, the figures in the example section). Advantageously, both the application of the adhesive and the bringing together of the printing substrate with the transfer foil can take place in a machine. The transfer foil itself comprises at least two layers, a transferable layer (=transfer layer) and another carrier material which carries this layer. The combination of the two layers is such that a transfer of the transfer layer via the adhesive onto the substrate is readily doable, that is, the adhesiveness of the adhesive with respect to the substrate and transfer layer has to be higher than the cohesiveness of the transfer layer and the adhesiveness of the transfer layer onto the carrier material. After the material transfer takes place, the substrate material contains both the structurally applied adhesive as well as transfer material as a transfer layer which likewise over the same, which is now also structured. This process can also be supported via the aid of pressure, temperature, and mechanical mechanisms such as embossing, contact pressing, etc. According to the invention, after the material of the transfer layer is transferred onto the substrate, this transfer material is, according to the invention, called the structured information layer, because due to its layout and the physical characteristics of the transfer material, it results in a capacitive readable structure, which can be determined by an appropriate reading device. The structured information layer thus represents the data contents of the data carrier.

In a particularly preferred embodiment, an at least the area of the substrate with the structured information layer covering further layer is placed, which may be, for example, a paper layer, a foil layer, a paint layer and/or a lacquer layer, whereby the said structured information layer is an applied transfer layer and where at least a part of the structured information layer simultaneously serves as a encoder for a capacitive reading device.

According to the invention, paper is preferably flat and mainly fibers of predominately vegetable origin comprising material which is produced on a sieve by drainage of a fibrous material suspension. This produces a fiber felt which is then compacted and dried. According to the invention, a paper layer is preferably made of completely natural, synthetic or partly synthetic papers. This may include also cartons or cardboard. Papers may, for example, be made of cellulose or partially synthetic papers in conjunction with organic plastics. The person skilled in the art knows that fully synthetic papers are also known as plastics and shall copy paper as a result of their technical properties.

According to the invention, a foil is preferably a thin, flat, flexible, coilable sheets, preferably made of plastic (such as cellulose acetate, polyvinyl chloride, polyethylene, polyethylene terephthalate or polypropylene) or cellophaning that can be applied as a foil and/or can form a foil layer.

According to the invention, a dye is preferably a colorant that is dissolved in a solvent, and where the dye includes natural and synthetic dyes. According to the invention, the paint layers refer to paints that can be dried preferably by absorption, by heat or by UV light, that is dyes. The person skilled in the art, however, knows of other methods or techniques for drying paints. Paints may for example be pigmented or be provided as a real solution. Examples of pigmented paints include paints filled with titanium dioxide or barium sulfate or obviously any other type of pigment or their combinations.

According to the invention, a lacquer means preferably a liquid or paste-like or powdery pigmented coating material that is applied to a substrate to provide a covering coating having protective, decorative or specific technical properties. A non-pigmented lacquer is preferably designated as a clear lacquer. Lacquer layers preferably include gloss and matte finishes. They can also serve as purely protective coatings, which are intended to protect the structured information layer. Lacquers include, for example, also artificial lacquers or natural organic or inorganic lacquers. However, other lacquers known to the person skilled in the art are also used.

According to the invention, adhesive materials or adhesives preferably comprise of non-metallic materials that connect the parts to be joined by surface bonding (adhesion), that offer internal strength (cohesion) and include organic and inorganic compounds. An adhesive or adhesive material of the adhesive layers may include permanent or non-permanent adhesive substances. Examples include aqueous as well as solvent-based adhesives or physically or chemically bonding adhesives. The term adhesive preferably also comprises of sticky materials of genuine organic origin which are designated by a person skilled in the art as glue. Adhesives or adhesive substances preferably include polyurethane, alkyd resins, epoxy adhesives, acrylates and thermoplastic polymers.

The teaching of the invention thus represents a combination invention for technical processing in which several elements are brought together to obtain a successful technical whole. It was surprising that the combination of the claimed elements would lead to a data carrier with surprising properties. The elements combined in the data carrier contribute to solving the consistent objective of the invention, as they mutually influence and complement one another and thus bring about the surprising successful technical whole according to the invention. The successful technical whole that depends particularly on the effects of the individual elements combined in the planar data carriers is the keystone of the inventive combination. Even if some parts of the combination have been described in the state of the art, their connection is not described nor suggested in the state of the art. It was completely surprising for the average person skilled in the art that the claimed elements can so functionally interact with one another that, for example, a data carrier can be produced with a single information layer within such a structured group of data carriers. The state of the art did not give the average person skilled in the art any suggestion on the arrangement in a data carrier of the elements of an electrically non-conductive substrate, preferably an adhesive layer, a structured, at least single-layered information layer, and at least one other layer covering at least one area of the substrate with the structured information layer, whereby the information layer is an applied transfer layer and where at least one area of the structured information layer serves as a encoder for a capacitive reading device. According to the invention, a encoder is preferably understood to mean a part of the information layer where the material of the transfer layer is on the substrate. The sum total of the encoder forms the information layer. By capacitive coupling with the reading device, these areas are identified as being different compared to the non-conducting substrate and can reflect signals from the reading device and/or forward them electrically.

The components according to the invention and the functioning of the data carrier are described in detail below.

According to the invention, as information layer the flat layout and design of the data carrier should be understood, which can be recorded and read using the appropriate reading principle and device.

The information layer/reading device system thus forms a meaningful unit. In a preferred embodiment, the reading area is smaller than the structured information layer. In a particularly preferred embodiment, the reading surface of the reading device is at least equal to the structured information layer.

According to the invention, the data carriers can be produced using different stamping techniques such as hot foil stamping and embossing. But all other printing processes known to the person skilled in the art can also be used such as letterpress, lithographic, rotogravure, screen printing or others. Of course, it is also possible to use electronic processes, such as matrix printing, electrostatic printing, electrolyte printing or other processes that are, at least in part, suitable for the production data carriers according to the invention. There is particular preference, however, for using the cold foil transfer technology. It was quite surprising that efficient capacitive readable data carriers could be produced using cold foil transfer technology.

The production by these methods is preferably effected so that a substrate or a planar carrier material has at least a partially adhesive material and/or an auxiliary agent applied to it, so that the carrier material is partly (structured in a layout) or completely coated. The structure formed by the adhesive and/or the auxiliary agent forms the layout for the next layer, the so called information layer. Adhesion of the metallic foil material to the adhesive areas is obtained by direct contact of the coated carrier material with, for example, metalized foil. Of course, it is possible to arrange for adhesion to non-adhesive areas. According to the invention, adhesive areas are areas that were treated with the adhesive material and are thus structured. In a following production step, the separation of the carrier material from the information material takes place, which results in a partially coated carrier material.

Both permanent and temporary adhesive materials could be used as the adhesive. Both aqueous and solvent-based adhesives are suitable for structuring and for the local detachment of the transfer layer as well as the physical or chemical bonding adhesives. The term adhesive also comprises sticky materials of genuine organic origin which are designated by a person skilled in the art as glues. Suitable is any appropriate component with adhesive effects to the transfer foil, preferably physically setting adhesives for offset printing machines. The physical effects preferably include temperature, but also light sources such as UV light.

The application of adhesives according to the specified layout is technically very easy in contrast to the at least partial removal of structures of a completely covering material. This is usually done by wet chemical processes such as etching and therefore greatly limits the choice of substrate and applied medium and is therefore disadvantageous. The determination of the layout of the information structure based on the adhesive has the further advantage of being very flexible with respect to making layout changes or amendments to the information layer. This is in a particularly preferred embodiment of offset printing involving the replacement of an offset printing plate or a rubber blanket.

Suitable methods for applying adhesives are preferably flat press, letterpress, gravure and offprint printing processes. Particularly preferred are offset printing and the inkjet methods.

The structured information layer may preferably comprise of metals, graphite, carbon black and/or dielectric materials, wherein the further layers comprise of at least one adhesive layer and/or at least a paper layer and/or at least one paint layer and/or a lacquer layer and/or a foil. In addition, the structured information layer may comprise metal-containing materials, such as cold foil with a layer of aluminum or other transfer layer materials or even dielectric materials or graphite and carbon black. Metals or metal-containing substances are particularly preferred, as they have good electrical conductivity, but also good thermal conductivity, as well as a very good ductility.

Preferred metals or materials containing metal include aluminum, lead, iron, gold, copper, magnesium, tungsten, zinc or tin. Of course it is also possible that the metals or materials containing metal include elements such as chromium, molybdenum or others. One can also imagine combinations and alloys thereof. Dielectric materials according to the invention mean any electrically weak or non-conductive, non-metallic substance, the charged carriers of which are generally free to move.

There are several possible ways to design the structure of the information layer.

It is preferred that the structured information layer comprises fill areas delimited by corners and/or curves, particularly of rectangles and/or circles, whereby the position, shape and/or the area are constituent parts of the structured information layer that can be identified by the reading device, and where these represent the information content of a certain number of data carriers. Advantageously, this can be, for example, geometric shapes such as rectangles, circles, or a combination of geometric shapes. But even indeterminate forms such as so-called free-hand shapes or randomly or pseudo-randomly generated structures may be preferred. The arrangement of the individual positions, but also the shape and surfaces of the structures, can be identified via a reading device, so that the structure or the form a code of a certain number of data carriers is, or can be, derived therefrom.

Preferably, the thus-prepared data carriers with the structured information layer can be supplemented by applying at least a paint layer in each case at least as a background, covering, number, letter, character, graphic representation, pictorial representation, or at least a combination thereof. According to the invention, this results in a group of data carriers comprising several data carriers, whereby
several data carriers with an identical structure of the information layer and at least one paint layer having the same design, to give a self-contained group of data carriers that are identical with respect to appearance and information technology,
several data carriers with an identical structure of the information layer and at least one paint layer having a different design, to give a self-contained group of data carriers that are identical with respect to information technology but different in appearance,
several data carriers with different structures of the information layer and at least one paint layer having the same design, to give a self-contained group of data carriers that are unique with respect to information technology, but identical with respect to appearance
several data carriers with different structures of the information layer and at least one paint layer having a different design, to give self-contained group of data carriers that are completely unique with respect to appearance and information technology

The information technologically unique data carriers can be obtained through different methods. Preferred, for example, are methods in which the structure of the information layer is applied in the form of an additive structure, or an additively applied and subtractively changed structure. The changing, modification or application of the said structure should be performed in such a way that the carrier material or the electrically non-conductive substrate is influenced little or not at all. An additive method according to the invention would, for example, involve the application of the structure via a screen printing machine or a printing machine with a cold foil transfer module. Insofar as additively-produced areas are also applied to the information structures produced by these methods, then according to the invention, this is a combination of additive processes. Of course it would also be possible to use additive processes such as digital printing or spray, inkjet, pad printing, embossing, hot stamping, dispensing or similar procedures.

In the combination of an additive with a subtractive or additive process, it is, for example, possible, after applying the structured information layer, to alter subsequently the structuring of the applied information layers in some areas via of additive and/or subtractive methods, preferably via inkjet methods (additively) and more preferably via laser methods (subtractive). Other possible methods for subtractive change in the structured information layer include, for example, stamping, punching, cutting, or electrostatic discharge or burning or soldering.

### Examples of the Production of Distinguishable Information Technology Codes

### Example 1

### Combination of an Additive with at Least One Subtractive Process

In an additive process (e.g. printing press with a cold foil transfer module), a structured information layer that represents a data blank is applied (see for example the figures in the example section). This data carrier blank is individualized in the next step and thus given a information-technologically distinguishable structured information layer which can be read as being distinctive. This individualization can be effected using one or more subtractive methods, for example by using optical (e.g. laser), mechanical (e.g. punching, stamping, cutting, water jet cutting), electrical (resistance heating, electrostatic discharge) or thermal (burning, soldering) processes. The areas of the data carrier blank that are removed or destroyed are so removed or destroyed at least in such a way that they are no longer recognized as the same type of (capacitive) areas. This approach is based on all the established principles of information mapping. In contrast, the individualization influences the carrier material little or not at all. The main objective is the processing of the information layer. All other data carrier blanks differ from one another in at least one position in order that each represents distinguishable information technology information.

### Example 2

### Combination of an Additive with at Least One Other Additive Process

In an additive process (e.g. printing press with a cold foil transfer module), a structured information layer is applied to a data carrier blank (see for example the figures in the example section). The data carrier blank is individualized in a further step by being transformed with at least one other additive process and thus, for example, enlarges, links, or bridges areas with structured information layers. There are no restrictions with respect to the shape or arrangement of the areas produced. This additive process is preferably a digital process, such as the inkjet process and can therefore produce individualized large volume data carriers.

As another example of using the additive process, the cold foil method should be mentioned. Here, the adhesive can itself be applied digitally to the data carrier and/or cold foil itself. By contact of the data carrier with the adhesive and the cold foil or the data carrier with the partially-adhesive cold foil, a further embodiment of the structured information layer (10) is obtained. The resulting structures represent the individualized data carriers. This approach can use all the principles of information mapping.

### Example 4

### Direct Information Mapping in the Subtractive Process

Purely subtractive methods require a full or partial coating of the information mapping layer, which is then also wholly or at least partially removed and/or destroyed. Such methods include, for example, etching, stamping, punching, cutting, cutting plotters and laser methods.

The formation of openings and/or other holes in the carrier material is not functionally necessary and depends more, less, or not at all on the subtractive manufacturing process. Depending on the method used, further steps can follow. Such steps are for example brushing, vacuum processes and printing processes.

Furthermore, various substrates are suitable for the production of the data carrier according to the invention. A non-electrically conductive substrate is preferred as a carrier material that can be made of paper, cardboard, wood products, composite materials, laminates, rubber or glass, or even a plastic, in particular, PET, ABS, PC, or others. More preferably, the carrier material is made of paper, cardboard or plastic. More preferably, the paper should be made from cellulose or wood pulp from groundwood. The paper may, for example, be in the form of board or cardboard. Board according to the invention means a working material by sticking or pressing together cellulose or waste paper. Cardboard may be in the form of one or three or more layers of paper material stuck together, where the outer layers and the intermediate layers are of the same or different composition, and where the outer layers are made of wood-free materials and the intermediate layers are made of wood-containing materials. A further preferred carrier material is plastic. Preferably, this would be polyethylene, polypropylene, polystyrene, polycarbonate, polyurethane, PVDF, polyethylene terephthalate or copolymers.

It is also preferred to add other optical, electrical, electronic, sensory and/or acoustic elements to the data carrier. In order to implement additional functions within the data carrier according to the invention, conductor tracks and electrical elements such as batteries, displays, sensors etc. can be attached using suitable additive procedures. Depending on the element and the method used, it may be preferable to effect the addition before or after creating the structured information layer. For this, the elements and their circuits may be attached both separately as well as galvanically coupled with the structures of the information layer. It may also be provided that the substrate in the initial state of the processing already contains elements, or parts thereof. Examples for this include piezoelectric substrates (PVDF foils) or substrates with piezoelectric content materials or areas.

In a further preferred embodiment, secondary information is attached to or contained in the data carrier. This secondary information, in particular, makes it possible to determine the orientation and/or speed of the data carrier relative to the reading device. Thus, the (mapped) information of the data carrier according to the invention in addition to the pure information data (for further processing), also includes other information (secondary information), such as clock signals. These clock signals can then be used to facilitate reading out of the data carrier regardless of the feed rate. This is especially useful if the data carrier is read, for example, dynamically (during movement, e.g. during insertion into a reading device). Moreover, it is conceivable that the clock signals can also be used as information structure or that the information structure and clock signal are meaningfully and logically inter-related. This can facilitate the correct interpretation of the data carrier. In the patent application DE 10 2007 029 384 A1, inter alia, different methods for storing and reading a code are described as well as tracking coactively readable information. The combination of the clock information track with pure information tracks is also described. The data carrier according to the invention can also contain (secondary) information or secondary structures which surprisingly help in the exact positioning of the data carrier in the reading device or can serve as a security feature or the like. It is therefore conceivable that the reading process is only triggered when at least the secondary structure covers one or more specifically associated positions in the reading device. This avoids the incorrect usage of the data carrier and offers increased copy protection against arbitrary data structures. This secondary information can also be used as data structures, or used in combination with these and evaluated. For example, the data density can be increased in the same available area. In any case, the data carriers according to the invention are both statically readable (data carrier is read while in a static position on the reading device), as well as dynamically readable (data carrier is read while moving, e.g. during insertion into a reading device).

In another preferred embodiment, features or elements can be added that contain additional optical information, in particular printed values, symbols, signs, security features and/or authenticity features, especially on game cards and/or collector cards.

It is particularly advantageous if this information represents a value that is constant, for example, with a game card or collector card in the course of their use or that can be decreased and/or increased.

The data carrier, particularly in the above-mentioned preferred embodiments, has the following advantages:
low-cost data carriers and low-cost reading device (as opposed to, for example, RFID solutions and optical solutions)
very good recyclability (unlike, for example, smart cards, which represent a multi-material composite)
physiologically harmless (especially important when used in children's toys)
manufacture of data carriers, both through reel-to-reel process as well as through the sheet process
easy individualization of structured information layer
direct product/packaging integration possible
process compatibility (only pure printing processes will be used)
contactless data transmission (as opposed to contact-type data carriers such as smart cards)
robustness (e.g. insensitive to contamination as not optical as opposed to barcodes and 2D barcodes, flexible and rigid design possible)
security (information from magnetic cards and RFID solutions can be copied, changed or destroyed very easily)
copy protection (information on (2D) bar codes can be copied very easily)
wide selection of materials for the substrate as well as the materials for the information layer
multiple use is a given (in contrast to, for example, numbered codes that lose their validity after entering)

The proposed invention is thus limited to known means or methods of production of capacitive structures as well as the use of these. Furthermore, a high degree of commercialization, as well as, for the first time, the possibility of the production of unique data carriers through mass production methods that also solves the optical enhancement of the product in a machine. Thus, this data carrier can be integrated into existing products without loss of time or special equipment, e.g. packaging and can be used in these either for product security and/or increasing sales. Product security using the RFID label in the ID1 format usually costs between 5 and 25 cents depending on the quantity and must be produced separately and applied to the packaging. With the proposed invention, both the application to the product is solved as well as making obsolete the use of different and distinct materials that need to be disposed of. In addition, the price is reduced in the given example to 20%, i.e. 4% of the RFID cost.

Below, the components according to the invention and the functioning of the reading device are described in examples of combination with the data carrier, without being limited to the embodiments given.

The invention relates to the use of a type of data carrier where the structured information layer is read via a reading device whose electrode arrays are so designed and arranged that the number and/or size and/or shape and/or position of the structured information layer of the data carrier is detected, recorded and data processed.

An example is given of a capacitive reading device used for decoding and for reading the applied information layer. Here the active surfaces (=reading electrodes and/or capacitor areas) are designed so that the information of the data carrier can be read without any uncertainty. According to the invention, the data carrier forms an integral component in the reading process of the reading device or a component with the arrangements of the reading electrodes within the same.

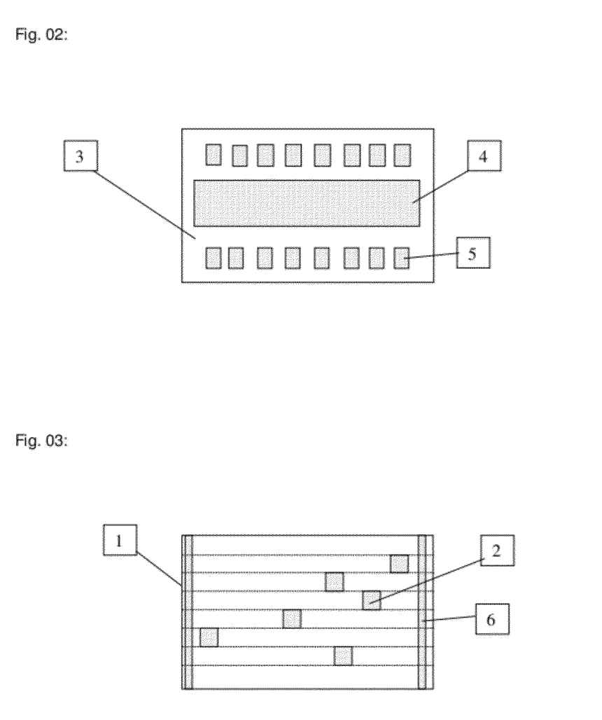

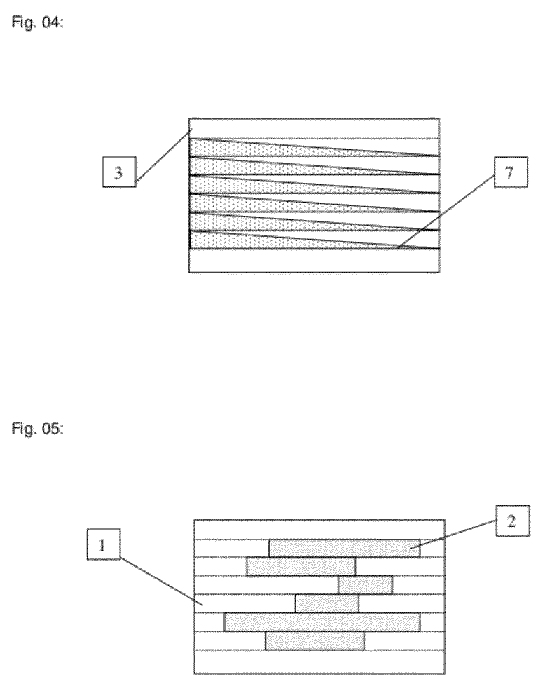

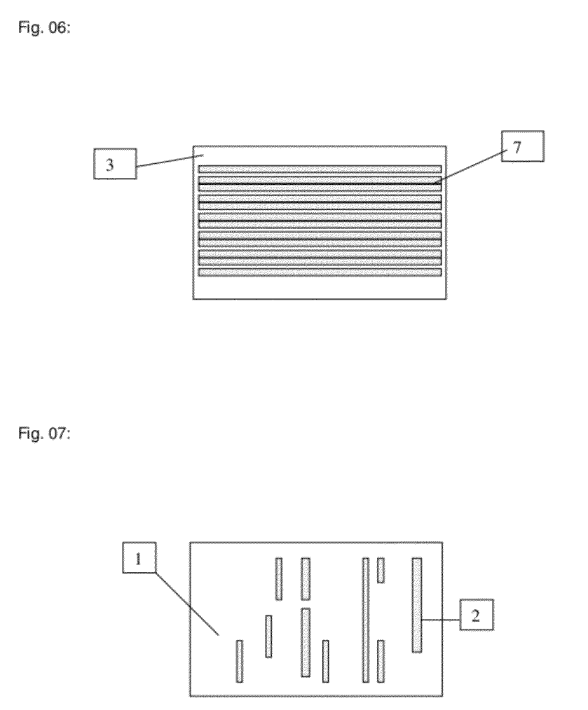

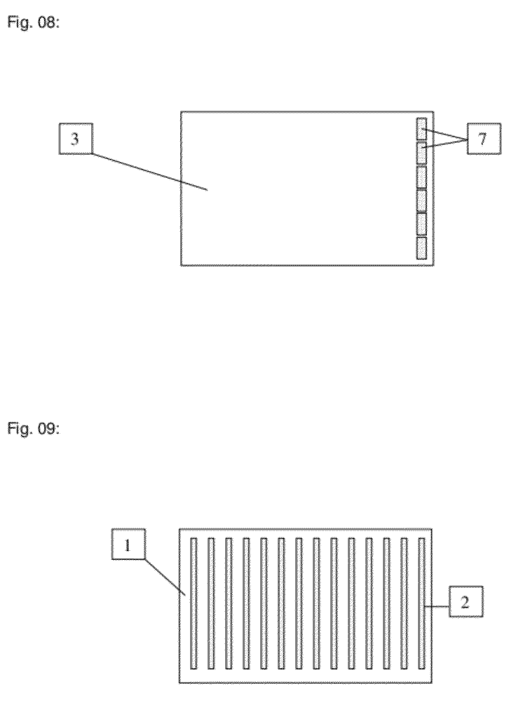

As a result, one can, for example, only read 16-bit data carriers via the reading device shown in FIG. 2, because there are 16 reading device electrodes available and can only accept the states 1 (encoder provided) or 0 (no encoder provided). For a variety of applications, for example ID cards or payment systems, it is necessary to have a higher memory capability. For this purpose, according to the invention, the generation of novel reading device surfaces (e.g. FIG. 4, FIG. 6 and FIG. 8) that do not follow the bit principle but rather use integrated, adding up and differential possibilities of information reading makes sense. As a result, the dimension of information is not limited only to the presence or absence of encoder structures, but, rather, is extended to depend on the relative position of the surfaces to one another, the relative sizes of the areas and the distribution. In experiments carried out, informational depths of 768 bits (2⁷⁶⁸ bits) for the size of a typical collector card have been obtained.

Data carriers are known from U.S. Pat. No. 3,719,804 and U.S. Pat. No. 4,587,410, which must be introduced into a reading device and the reading device must have stops and guides to ensure the correct positioning of the data carrier. The data carriers according to the invention are also readable with this type of reading device but are not limited to them. The data carriers according to the invention also allow, in preferred embodiments, the positioning or stopping of the data carrier with respect to a reading device surface. Other elements, so-called secondary information elements (such as FIG. 2, FIG. 4, FIG. 6 and FIG. 8), can be provided on data carriers within the structured information layer, which allow the reading device to determine the orientation of the reading electrodes relative to the data carrier. The secondary information elements may preferably be applied using the same procedure as the data carrier content itself. The use of secondary information elements for the relative orientation is preferred, but is not limited only to this.

This allows a reading method to be implemented that is independent of the position of the data carrier on the reading device. This is an important improvement compared to the state of the art, because the inserting and positioning processes take time and, for example, slow down or hinder the quick and easy usability of the data carriers and the reading device. It is also advantageous within the current state of the art, to have data carriers that can be correctly read even when they are put into an incorrect position intentionally or unintentionally. In addition, after repeated use, paper and other soft materials show wear and tear, become dog-eared, torn or have wavy edges which affect the reading process, especially in reading devices with a slit. These problems are solved according to the invention. It is particularly preferred if the reading device of the data processing system has a slot, a slit and/or a supporting surface to accept at least a portion of the data carrier. The data carrier can be inserted into or onto the reading device, pulled or pushed through, positioned carefully or at random. This means that the data carrier can be set down or positioned anywhere in, at or on the reading device. Combinations of the positions may also be preferred. This is, for example, dependent on the application, the customer requirements or environmental influences or by the presence of peripheral electronics such as game machines. In further preferred embodiments, the data carrier can at least partially be pulled or pushed through with respect to the reading device.

After a successful reading process, the invention relates to the use of the data carrier as a link to an action or a data set in a data processing device, whereby the reading device itself can already constitute a data processing device. The structured information layer of the data carrier is, e.g., converted into a code by the reading unit, and sent to a data processing device. This data processing device can then assign this code to a corresponding action or a data set. This data set can be, for example, files (pictures, videos, texts), web pages, database entries (user identification, game characteristics, game items), computer programs that are started or influenced and/or the interaction and/or combination of these technical features. According to the invention, this assignment of the data storage can be developed to be application dependent. It is preferred that the information on the data carrier will be assigned to a data set in a data processing device and that this remains constant or is changed over the course of its use. For example, the assigned data set can be increased in value for each use of the data storage or also remain constant.

For example, a data carrier is shown in FIG. 1, which can be read (given as an example in the figures) with the associated reading device. In the reading process, the information is displayed in accordance with the bit principle as 0011111101111110 (top left to top right, bottom left to bottom right). This structure corresponds exactly to this code and each identical structure would correspond to the same code. Thus a group of identical data carriers is created. In the particularly preferred embodiment of the invention of a collector card game, for example, this code can be linked to a file, software or parts thereof which are centrally or decentrally located on a data processing system.

It is preferred that the data carrier in connection with the reading device is, via its structured information layer, associated with an action of a data processing system or trigger the same, preferably this applies to actions on non-networked data processing systems, and more preferably to networked computer systems. Non-networked systems according to the invention are described as autonomous systems, i.e. independent systems that are not networked. Examples include game consoles and non-networked computers. Networked systems according to the invention include systems that are physically or not physically connected to one another. Examples of physical connections include cable connections while non-physical connections include wireless connections. The data carrier may be read in a data processing system, such as a computer, whereby the computer can have Internet access. By this, the information on the data carrier can be transferred.

According to the invention, first-order forms, such as rectangles, circles, squares or lines etc are preferably used for the representation of the information structures. In a further preferred embodiment, second-order geometric shapes in the form of a combination of circles, rectangles, squares or lines, or as variations of these can be used. In a further embodiment, geometrically indeterminate forms such as writing, codes, scripts or art and/or imaginative shapes (examples are shown in the figures) enable the information mapping.

The resulting product is a data carrier that can be processed further in subsequent steps. The subsequent steps are preferably as follows:
Lamination with a counter-surface (made of the above-mentioned support materials)
Lamination with the same or similar data carrier
Printing in the flat-press, letterpress or gravure printing for optical processing and possibly optical obliteration of the applied information layer
Printing in the flat-press, letterpress or gravure printing for further processing with security and/or authenticity features (holograms, guilloche patterns, micro text, other codes, etc.)
Finish coatings (anti-scratch layers, (clear) lacquer coatings, mirror surfaces, peel-off surfaces, anti-reflective coating, adhesion promoters, tactile layers (felt, plush, leather, plastic haptics), odoriferous materials
Embossing (Braille, embossed writing, beautiful embossing)
Application of further adhesive layers and/or transfer layers
Application of optical, electrical, electronic, sensory and/or audio elements (such as conductors, humidity/temperature sensors, acceleration sensors, position sensors), as well as energy storage and conversion systems (such as solar cells, batteries)
An intermediary layer, which may simultaneously provide a barrier and/or screening function

The data carrier and the data processing system according to the invention may be used for different purposes and therefore have many applications. These include the application of the data carriers as game cards and collector cards, but also as stamps on a letter (franking or postage) in the logistics and goods tracking areas, but also for admittance to events in the form of tickets. It is particularly advantageous that some VIP or enclosed areas can also be measured statistically and visualized. Also advantageous is the application to marketing applications for customer loyalty, lotteries and sweepstakes, or as a membership card, forgery protection, copy protection, but also for payment applications or for signatures, certificates or certificates of authenticity. Particularly advantageous is the use as items within a computer game or in the downloading of music, video or e-books, but also for bonus stamps or similar programs or gift cards. It can be particularly advantageous if the data carrier is used only in combination with at least one other data carrier that then completes the information content of the latter and thus frees access to another data set. This can be especially beneficial in the case of access to critical areas such as game worlds, lotteries, puzzles, chat rooms; in this case, two or more data carriers are used to provide technical information to allow access and thus obtain higher access security.

In the following, a particularly preferred embodiment of the invention is described as an example of the collector/game card application, but that is not limited to this application.

Many consumers, for example children, now buy a collectible card game. These collector cards are data carriers working in accordance with the principle described here involving a unique code that is readable by a reading device. This reading device is equipped with an interface for a computer, console or mobile phone. The reading device could also be provided and be usable in certain environments, such as a video store or in game machines.

Until now children have played with their cards according to predetermined rules or their own, for example, in the school playground. This is done firstly by a comparison of one of the values on the cards and secondly by the combination of several complementary card values. According to the rules, a losing card is removed from the game or given to the opponent. In addition, the cards can be swapped or traded. Until now, there has been no way for the real cards to be used on a PC, a game console or a mobile phone in order to collect, exchange or play with the cards directly against virtual or real opponents. So far, children have had to participate at regular intervals in tournaments in order to compete with others, to swap cards or to present their collection.

The system described allows children to play their collector card game as usual in the traditional way (by comparing optically applied values and symbols) and also to have the opportunity to play with their collector cards and a reading device such as a PC, a game console or a mobile phone. This means that by installing the game or by calling a website with an integrated game, they can get offline or online access to a virtual world where they can trigger all kinds of action by means of their cards and the associated reading device.

They may, for example, collect their cards in an Internet album and also allow access to this Internet album, so that their friends can see what cards they have. In addition, they can exchange their real cards and, when their card is being used by someone else, it immediately disappears from their own album and appears in the album of the new owner. Furthermore, they can control a computer game with their cards, whereby they insert the correct cards at the correct time into the reading device connected to a computer, console or mobile phone. They also have the possibility of playing directly against their friends, or other real or virtual opponents on the Internet. This means that complete tournaments that have previously taken place in large venues with the children physically present are very easy to arrange on the Internet. This thus saves the producers of the games the effort of the organization and the players the effort of traveling. But for this to succeed, it is essential that the cards cannot be copied. Until now in tournaments, the authenticity of the cards was checked on the basis of the appearance and security features. Once children can play online however, the cards can no longer be checked by the referee. This means that the system described here offers considerable value with respect to the non-copy ability of the cards.

The possibility of clearly identifying each card in circulation creates more opportunities for using the cards. Thus, the history of each card can be stored in a central online database via the computer, game console or mobile phone. This history will record, how often a card has won or lost, or how often it has been used or who had used it until now. One can also determine in which cities or countries the card was used before. The card thus develops a value within the game software that can affect the game positively or negatively depending on the game concept. Winning streaks are recorded and have an impact on the game. All these functions are ideal for establishing a game community in computer games using a data connection via, for example, the Internet.

This represents a dramatic improvement over the current state of the art. Although the optical copying and/or reproduction of these game cards is possible using photocopiers, scanners, and other reproduction media to the same extent as with conventional game cards, the data carrier media itself is not copied, however, and thus the originality is preserved. This represents a special novelty with respect to the technical state of the art.

The invention is explained below by way of example with references to figures, but is not limited to these examples.

The figures show:

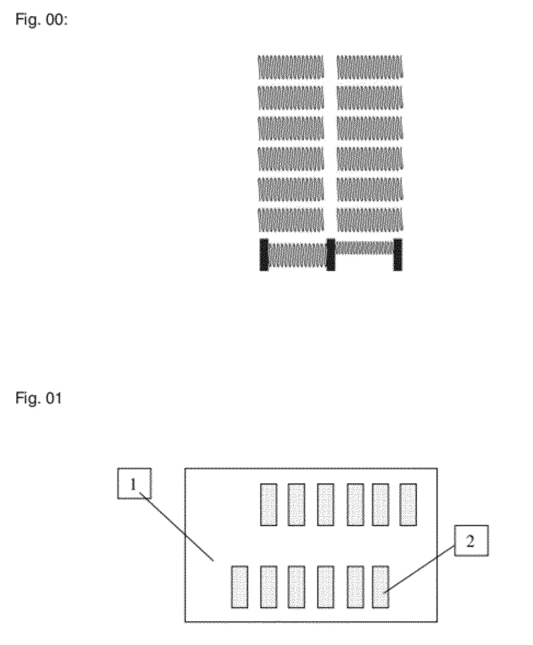

FIG. 00 Wave-shaped representation of the information mapping layers

FIG. 01 Planar data carrier according to Principle 1 with a rectangular data structure (top view)

FIG. 02 Example of a reading device for planar data carrier recognition according to Principle 1

FIG. 03 Planar data carrier according to Principle 2 with sequential quadratic data structure (view from above)

FIG. 04 Example of a reading device for planar data carrier recognition according to Principle 2

FIG. 05 Planar data carrier according to Principle 3 with sequential quadratic data structure (view from above)

FIG. 06 Example of a reading device for planar data carrier recognition according to Principle 3

FIG. 07 Planar data carrier according to Principle 4 with linear data structure (view from above)

FIG. 08 Example of a reading device surface for data carrier decryption according to Principle 4

FIG. 09 Data carrier blank with information mapping layer

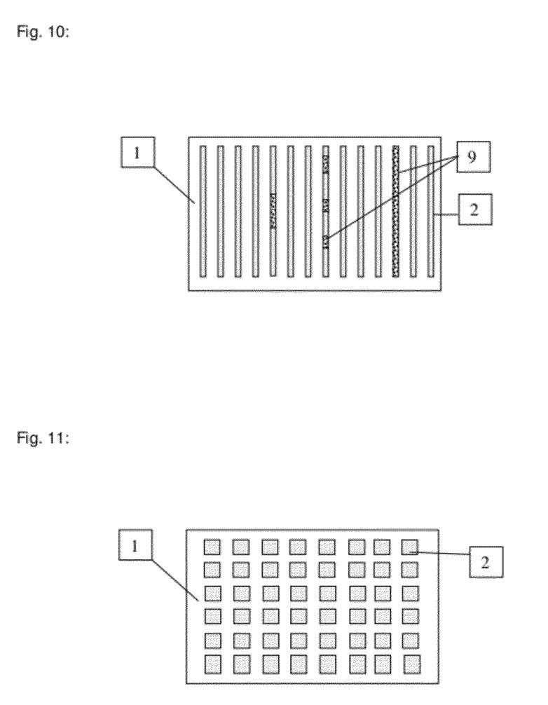

FIG. 10 Data carrier blank after successful individualization

FIG. 11 Data carrier blank with information mapping layer

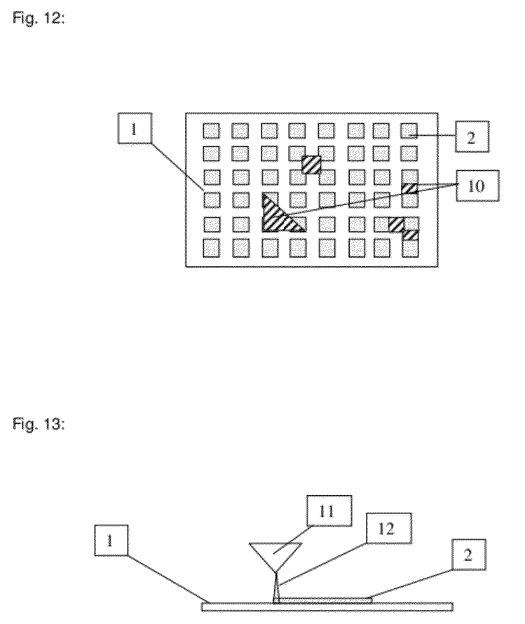

FIG. 12 Data carrier blank after successful individualization

FIG. 13 Production of a data carrier with information mapping layer using spray application (side view)

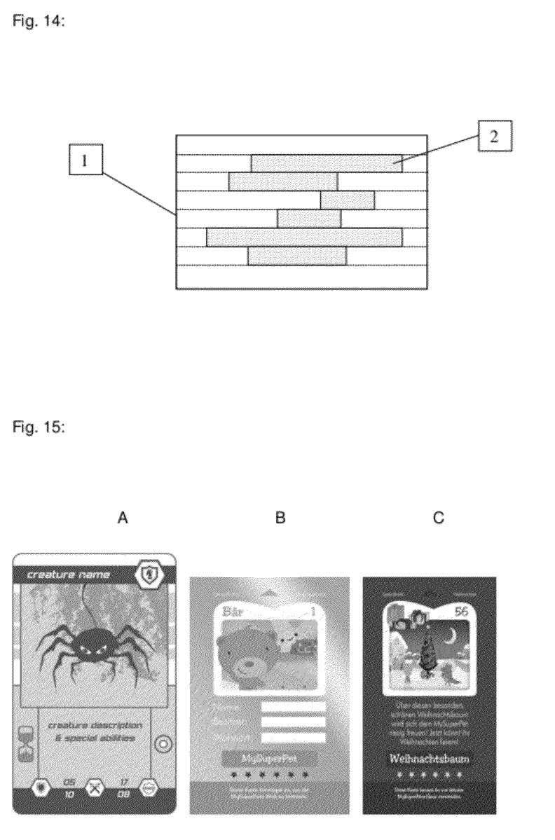

FIG. 14 Data carrier according to FIG. 13 viewed from above

FIG. 15A-C Examples of game cards and collector cards according to the invention

FIG. 01 shows a planar data carrier according to Principle 1 with a rectangular data structure (view from above). Principle 1 is set out as an example. Here, the substrate 1 and the structured information structure are represented (example of rectangular embodiment) 2.

FIG. 02 shows an example of a reading device surface for data carrier recognition according to Principle 1. Here are represented the support material, or board 3, a reading electrode 4 (optional for signal coupling or pick-up) and a read electrode for bit detection 5 (counterpart to 4—available for signal coupling or pick-up).

FIG. 03 shows a planar data carrier according to Principle 2 with a sequential quadratic data structure (view from above). Here, the substrate 1, the structured information layer 2 and secondary information 6 are represented.

FIG. 04 shows an example of a reading device surface area for data carrier recognition according to Principle 2. The carrier material or the board 3 and the reading device electrode 7 are represented in detail.

FIG. 05 represents a planar data carrier according to Principle 3 with a sequential quadratic data structure (view from above). The substrate 1 and the structured information layer 2 are shown.

FIG. 06 shows an example of a reading device surface for data carrier recognition according to principle 3. Here, the carrier material or board 3 and the reading electrodes 7 are shown.

FIG. 07 provides an example of a planar data carrier according to Principle 4 with a linearly-shaped data structure (view from above). The substrate 1 and the structured information layer 2 (linearly shaped embodiment) are shown.

FIG. 08 shows an example of a reading device surface for data carrier recognition according to principle 4. The carrier material or the board 3 and the reading electrode 7 are shown as a capacitive embodiment. The structure of the reading electrode 7 must read the data carrier line by line, consecutively.

FIG. 09 shows a data carrier blank with an information mapping layer. Here, the substrate 1 and the structured information layer 2 are shown, whereby the structured information layer 2 is in a linearly shaped embodiment.

FIG. 10 represents a data carrier blank after individualization. Here, the substrate 1, the structured information layer 2 (in a linearly shaped embodiment), and destroyed areas of the original data blank/information layer 9 are shown.

FIG. 11 shows a data carrier blank with information mapping layer. The substrate 1 and the structured information layer 2 are represented.

FIG. 12 represents a data carrier blank after individualization. The substrate 1, the structured information layer 2 and an additional generated information layer on the original data carrier blank 10 are shown.

FIG. 13 shows the production of a data carrier with an information mapping layer using a spray application (side view). Here, the substrate, the structured information layer 2, the spray head 11 and the material for information mapping 12 are represented.

FIG. 14 represents a data carrier according to FIG. 13 viewed from above. Here, the substrate 1 and the structured information layer 2 are shown.

FIG. 15A-C shows examples of game cards and collectible cards according to the invention. The cards can be printed with various designs in various colors.

### REFERENCE LIST

1 substrate

2 structured information layer

3 carrier material or board

4 reading electrode

5 reading electrode for bit recognition

6 secondary information

7 reading device electrodes or reading electrodes

9 destroyed areas of the original data carrier blank/information layer

10 additional information layer generated on the original data carrier blank

11 spray head

12 material for information mapping

1. Data carrier, comprising
an at least sectionally applied adhesive layer is arranged on an electrically non-conductive substrate, an at least single-layered information layer congruently applied thereto, wherein the said adhesive layer and information layer are layers applied as coatings by a transfer process, preferably through a foil transfer method and more preferably through a cold foil transfer method and wherein at least a portion of the structured information layer serves at the same time as an encoder for a capacitive reading device.

2. Data carrier according to claim 1, wherein
at least an area of the substrate covered by the structured information layer has another layer arranged over it that can be, for example, a paper layer and/or a foil layer and/or a paint layer and/or a lacquer layer or combinations thereof.

3. Data carrier according to claim 1 wherein
the information layer comprises metals, graphite, carbon black and/or dielectric materials while the remaining layers comprise at least an adhesive layer and/or at least a paper layer and/or at least one paint layer and/or a lacquer layer and/or a foil.

4. Data carrier according to claim 1 wherein
said structured information layer comprises fill areas delimited by corners and/or curves, particularly rectangles and/or circles, and wherein the position, shape and/or the area themselves serve as components of the structured information layer and can be detected via a reading device that can display the information content of a certain number of data carriers.

5. Group of data carriers comprising several data carriers according to claim 1, wherein
at least one paint layer, adhesive layer, paper layer and/or foil is applied in each case at least as a background, coverage, number, letter, character, graphic representation and/or visual representation or a combination thereof, wherein
several data carriers have the same structure of the information layer and at least one paint layer having the same design, so that a self-contained group of information-technologically and visually identical data carriers is obtained,
several data carriers have the same structure of the information layer and at least one paint layer having a different design, so that a self-contained group of information-technologically identical and visually different data carriers is obtained,
several data carriers have a different structure of the information layer and at least one paint layer having the same design, so that a group of information-technologically unique but visually identical data carriers is obtained,
several data carriers have a different structure of the information layer and at least one paint layer having a different design, so that a completely, that is visually and information-technologically, unique data carrier is obtained.

6. Data carriers according to claim 1, wherein
the structuring of the applied information layers is changed sectionally via additive and/or subtractive methods, preferably by inkjet methods and more preferably through modification by laser methods.

7. Data carriers according to claim 1, wherein
the substrate comprises paper, cardboard, wood products, composites, laminates and/or plastic.

8. Data carriers according to claim 1, wherein
other optical, electrical, electronic, sensory and/or acoustic elements are applied to the data carrier.

9. Data carriers according to claim 1, wherein
secondary information can be applied onto or be contained by the data carrier, in particular to enable determining an orientation or speed of the data carrier relative to a reading device.

10. Data carriers according to claim 1, wherein
features and/or elements are further attached that contain additional optical information, in particular printed values, symbols, signs, security and/or authenticity features, especially on game cards and/or collector cards.

11. Method of detecting, capturing and processing the structured information layer of the data carrier of claim 1, wherein
the structured information layer is detected, captured, and data-technologically processed further via a reading device who electrode arrangement is so designed and arranged that the number and/or size and/or shape and/or position of the structured information layer of the data carrier.

12. Method comprising attributing to or triggering an action of a data processing system wherein
the data carrier of claim 1 in conjunction with a reading device via its structured information layer is associated with or triggers said action wherein this preferably applies to actions on non-networked data processing systems, and more preferably on networked computer systems.

13. Method comprising
associating the data carrier of claim 1 with a data set in a data processing device and the data carrier remains constant or changes during its use.

14. Method comprising:
providing the data carrier of claim 1, wherein the data carrier is used for game cards, collector cards, stamps, franking, postage, goods logistics, goods tracking, admission, admission tickets, access to closed areas, virtual content, marketing applications, customer loyalty, lotteries and sweepstakes, membership cards, time cards, payment applications, authenticity certificates, forgery prevention, copy protection, signatures, delivery bulletins, items within a computer game, music/video/e-book downloads, bonus stamps/programs or gift cards.

15. Method comprising:
providing the data carrier of claim 1 and
completing an information content of said data carrier only in combination with at least one other data carrier and
thus clearing an assignment to another data set.

16. Data processing system,
comprising the data carrier of claim 1, wherein
the reading device has either a recess, a slot and/or a support surface to accept at least a portion of the data carrier while the data carrier is presented or placed anywhere in, on, or at the reading device.
